(19) United States
(12) Patent Application Publication
(10) Pub. No.: US 2014/0226032 A1
(43) Pub. Date: Aug. 14, 2014

(54) Photo booth with graphic code indentification, procedure for securely sending and accessing photographs made by the photo booth, and the photographic product obtained

(71) Applicant: DIGITAL CENTRE, S.L., Sant Fruitos de Bages (Barcelona) (ES)

(72) Inventor: Josep TARRES BOLOS, Manresa (Barcelona) (ES)

(21) Appl. No.: 14/078,349

(22) Filed: Nov. 12, 2013

(30) Foreign Application Priority Data
Sep. 11, 2012 (ES) 201231718

(51) Int. Cl. H04N 1/00; H04N 5/222

(52) U.S. Cl. CPC H04N 1/00278; H04N 5/222; H04N 2101/00
USPC 348/207.2

(57) ABSTRACT

This invention refers to a new photo booth with means for reading graphic codes, which carries out a process of sending and accessing photographs in digital format in a secure and instant manner from a photographic product that includes a graphic code associated to each of the photographs taken, identifying them and associating them to a location on an external database.

### OBJECT OF THE INVENTION

More specifically the invention refers to a new process of sending and accessing photographs in digital format in a secure and instant manner from a photographic product obtained in a photo booth advantageously configured for this purpose.

### STATE OF THE ART

Photo booths currently offer the user an optional function of sending the photos made by it to the devices, social networks or email account the user indicates.

This sending of photos implies that the user must be identified beforehand or needs to enter the necessary data the moment of sending, in order to to send correctly. In each case, data must be supplied to the photo booth such as an email account, phone number and in the case of interaction with social networks, passwords so as to be able to automatically share the photos obtained.

This procedure becomes a problem for secure data management, as this data could be seen by third parties in the vicinity, and they are entered into equipment that has a private management, from which the users' data could be obtained.

In addition, there is the problem of errors when indicating the sending data the moment the user enters it, as well the possibility of not remembering the passwords both of identification in the photo booth, and the social networks which the wish to sent it to so as to be able to automatically add the photos.

All of this causes lack of security and privacy with regard to to data and management of the photographs taken in existing equipment.

### DESCRIPTION OF THE INVENTION

This invention is based on the creation of a photographic product by a photo booth that allows quick and secure access to the digital format of the photographic product.

The photographic product created by the photo booth has a graphic code associated to each of the photographs taken, identifying them and associating them to a location in an external database, where they are sent automatically the moment they are taken.

When they are printed, these photographic products advantageously incorporate one or more graphic codes for identification and access, thus the user only needs a device able to read this type of code, so it can be read when connecting the device with the location of the digital photograph file, without having to manually enter Website addresses or having to search for the photos in a Web platform and there enter passwords to access the photographs.

This is achieved in a secure and automatic manner, therefore, in addition to the user not having to enter personal data in the photo booth regarding the destination of the digital format photographs, there is an automation of access to them without having to enter the hosting address to access.

To create this product and have these benefits when using the photo booth, the device will include the habitual features all photo booths need for operation, such as means to take pictures and for printing-reproduction, as well as the habitual means for payment, computation systems that enable the execution of applications that enhance the usage possibilities of the photo booth, as well of means for connecting to telematic networks to communicate the photo booth with external devices, and in addition to these habitual features, it incorporates a module for creating graphic codes uniquely related to the files and the location the photo booth sends them to.

The photo booth also incorporates means to read the graphic codes, to identify users who wish to make use of the photo booth, enabling them to further automate the procedure for obtaining the photographs, as their prior identification through a graphic code allows at the same moment the photographs are taken, that the code generated by the photo booth be associated with the user's code, and the external database once the photographs are received from the photo booth, by means of resources that relate these codes and the data of associated devices, sending them directly to the user's device.

Obtaining this user identification code needs prior registration of the user in the external database, which generates a unique personal identification graphic code by means of a module to create graphic codes, from the indicated data of username and the device where the graphic code and the photos are to be received, automatically. This maintains confidentiality, as the photo booth relates a user and a code for the photographs, without holding any more of the user's personal data.

The database will hold no other data apart from username, code assigned and means of communication with the mobile device. This enables the automatic incorporation of these photos to social networks if the mobile device carries out this process automatically. Alternatively, if it is decided to include the corresponding permissions to access the user's social networks in the database, they will automatically be sent to these networks.

This sending of the user's graphic identification code can be done in a single event, having a single code associated to a unique user, or receiving a new code for each use, which although it always identifies the user in the database, it is different for each use so as to avoid copies of the code being used.

Therefore, the procedure for securely sending and accessing photographs made by a photo booth in digital format is as follows:
The photo booth takes the user's pictures when the user begins the photographic process.
These photographs, when validated by the user (they can be modified by the applications built into the photo booth) are sent to an external database by telematic networks, assigning a graphic code to the photographic product obtained by the photo booth, by means of the graphic code creation module in the photo booth, which include the information of the photo file and its location in the database.
If the user has been identified in the photo booth through a graphic code, the photo booth links the graphic code of the photographic product with the user's code, sending this link with said photographic product to the external database. This external database will automatically send the photographic product obtained, to the device or web location the user has indicated.
Once the photographs have been taken, the user obtains a photographic product that incorporates a graphic code identifying the file and its location in the external database, which is directly read by means for reading graphic codes, and it executes the information it contains automatically.
The user can use any device for reading graphic codes and with access to the web, so as to obtain said photographic product in digital format automatically without having to enter addresses or passwords.
It is possible for the user to define in the mobile device that said device send the photographs obtained automatically to the desired social networks.
The user, when registering in the external database, may enter personal data, contact devices and access data to areas in the web, so as to automate the process of uploading the photos to social networks.

Other details and characteristics shall be shown throughout the description below referring to drawings attached to this report which are shown for illustrative but not limiting purposes only in a drawing of the invention.

### DESCRIPTION OF THE DRAWINGS

FIG. 1 shows a prospective view of a photo booth with means to read graphic identification codes.

FIG. 2 shows a strip of photographs obtained.

FIG. 3 shows a block diagram of the procedure for sending and accessing the digital photographs.

### DESCRIPTION OF AN EMBODIMENT OF THE INVENTION

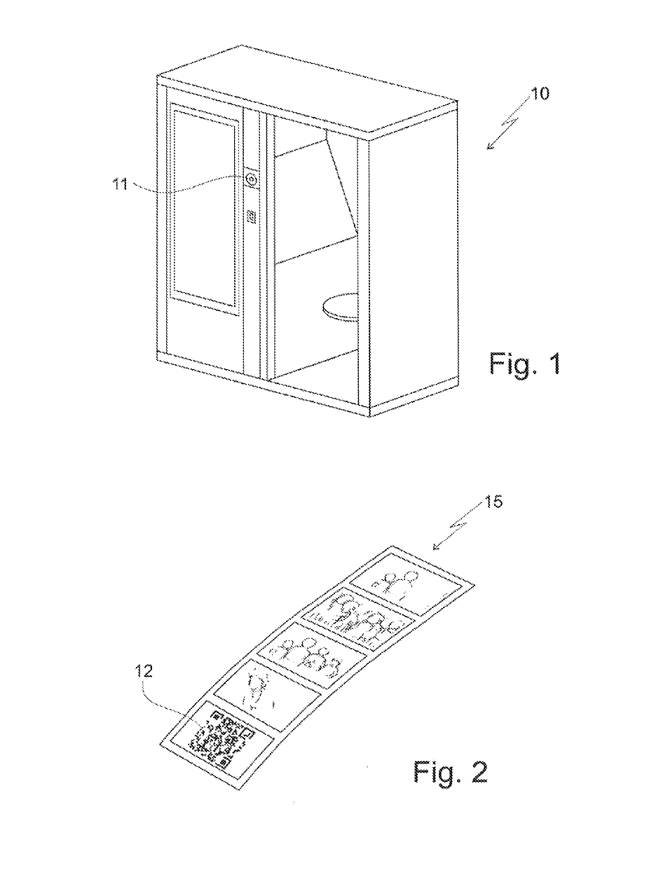

One of the preferred embodiments of the invention, as shown in FIGS. 1 and 2, comprises a photo booth (10) that enables automatic identification of the user and the creation of a photographic product, in this case a strip (15) incorporating a graphic code (12), normally of the QR type.

To be able to do this, the photo booth (10) has the habitual features that any photo booth needs to work, incorporating means (11) for reading graphic identification codes (12), a module (14) to create these graphic codes (12) and access to an external database (13). These identification codes (12) produced by the module (14) incorporate at least the information to identify the photographic product obtained in digital format and the route to reach its location in the database (13).

These means (11) for reading are normally cameras adapted for recognition of codes (12); either QR type, barcodes or others that can be displayed to these means so they will identify the user and the actions the user carries out on them. Alternatively, there may be means (11) for reading based on other types of technology such as infrared or other alternatives.

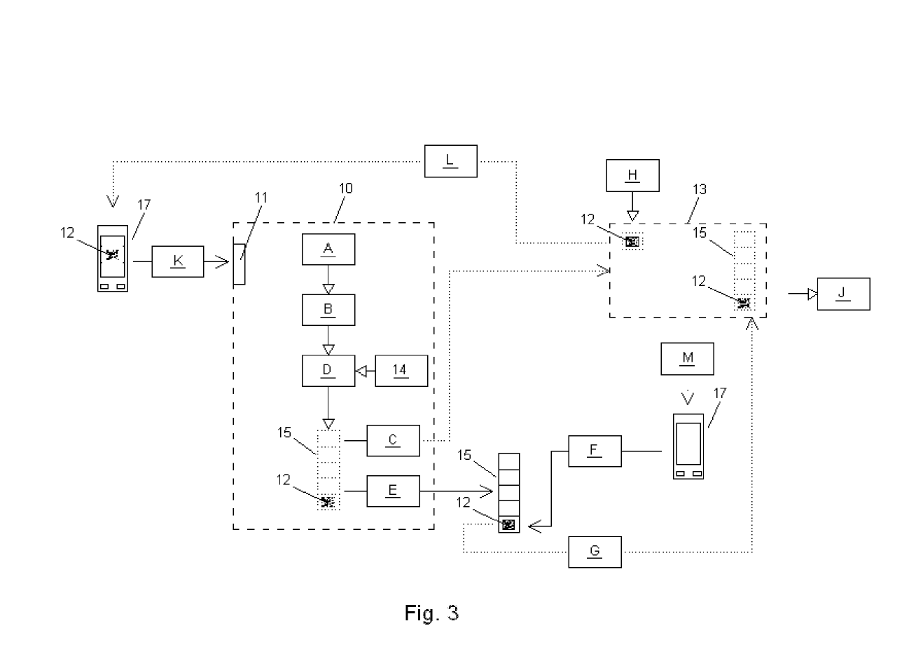

To obtain this strip (15) with the graphic code (12), the photo booth (10) carries out the following procedure, as can be seen in FIG. 3:
When the photo booth (10) takes pictures (A) at the user's request and the user validates them after possible modifications (B), the photo booth (10) will create (D) a unique graphic code (12) by means of a module (14) for creating graphic codes (12), which are associated both to the identification of the digital photos and their location on the database (13), and the photo booth (10) sends (C) these photographs in digital format to an external database (13) which it connects to by means of a telematic system.
The photo booth (10) prints (E) the strip of photos (15) for the user, accompanied by a graphic code (12) for identification, created by the photo booth (10).
The user, by means of a mobile device (17) with capacity to recognise these graphic codes (12), reads (F) the corresponding graphic code (12) on their photographs and automatically connects (G) to the website where the photographs are, in the database (13), and is thus able to access (M) the photographs in digital format.
The prior registration (H) of the user in the external database (13) associates the username to a unique graphic code (12) which will be created before using the photo booth (10), and that at the moment of identification, when the user displays (K) the graphic code (12) (sent (L) by the database (13) to the user) to the reading devices (11) it has, the photo booth (10), using its means for relating codes, associates the code (12) of the photographs taken with the user's graphic code (12), which has the data of the devices (17) associated to it, sending (J) the photographs automatically from the database (13) to the mobile device (17) associated with the user.

Alternatively, as an option to the process, the following is possible:
It is possible for the user to define in the mobile device (17) that said device (17) send the photographs obtained automatically to the desired social networks.
If the user, when registering in the external database (13), may enter personal data, contact devices (17) and access data to areas in the web, so as to automate the process of uploading the photos to social networks.

This process carried out by the photo booth (10) produces strips of photographs (15) that include a graphic code (12) on the strip (15) of pictures, this graphic code incorporates the identification of the photographic product and the route of its location in the corresponding space of the telematic system so that its access or downloading, as its linking with the identification code of the user, if the user had previously identified him/herself.

Having sufficiently described this invention using the drawings attached, it is easy to understand that any modification may be made to the detail which may be deemed to be appropriate, whenever these changes do not alter the essence of the invention summarised in the following claims:

1. A photo booth with graphic code identification including a means for capturing pictures made by the user, a means for printing the photographic product obtained in it, and a means to connect telematic communication networks in order to send the photographic product in digital format, characterised in that the photo booth comprises a means for reading graphic code for automatic user identification, and a module for generating graphic identification codes.

2. A photo booth with graphic code identification according to claim 1, characterised in that the means for reading graphic codes comprises a camera for recognition of QR codes.

3. A photo booth with graphic code identification according to claim 1, characterised in that the photo booth's connection means keeps the photo booth in communication with an external database.

4. A photo booth with graphic code identification according to claim 3, characterised in that the database has a module for generating users' graphic identification codes, a space for the location of photographs taken, and a means to relate the identification code of each photographic product, the user's identification codes and the devices related to the users.

5. A photo booth with graphic code identification according to claim 1, characterised in that the module for generating graphic codes comprises an encoder of the website addresses related to the database, the identification of the files stored there, and the graphic identification codes of the user, in QR type formats.

6. A procedure for securely sending and accessing photographs made a photo booth according to claim 1, which uses means of connection to telematic communication networks, takes the photographs, and enables the user to modify the photographs using applications in the photo booth characterised in that:
when the photo booth takes pictures photographs at the user's request and the user validates them after possible modifications, the photo booth creates a unique graphic code by means of a module for creating graphic codes, which are associated both to the identification of the digital photos and their location on the database, and the photo booth sends these photographs in digital format to an external database which it connects to by means of a telematic system;
the photo booth prints the photographic product for the user, accompanied by a graphic code for identification, created by the photo booth;
the user, by means of a mobile device with capacity to recognise these codes, reads the corresponding code on the photographs and automatically connects to the website where the photographs are, in the database, and is thus able to access the photographs in digital format; and
the prior registration of the user in the external database associates the username to a unique graphic code which will be created before using the photo booth, and that at the moment of identification, when the user displays the graphic code, which the database sent to the user, to the reading devices, the photo booth, using its means for relating codes, associates the code of the photographs taken with the user's code, which has the data of the devices associated to the user, sending the photographs automatically from the database to the mobile device associated with the user.

7. The procedure for securely sending and accessing photographs made by a photo booth according to claim 6 characterised in that the process of sending the photographs obtained in electronic format to the social networks linked to the user is automated when the user indicates in their mobile device or in the database permission to access the social networks.

8. A photographic product obtained by the photo booth defined in claim 1, being formed by one or more photographs characterised in that the one or more photographs incorporates at least a graphic identification code of the photographic product and the route of its location in the corresponding space of the telematic system for access or downloading.

9. The photographic product according to claim 8 characterised in that the graphic code comprises a linking with the identification code of the user.

10. A photo booth with graphic code identification according to claim 4, characterised in that the modules for generating graphic codes comprise an encoder of the website addresses related to the database, the identification of the files stored there, and the graphic identification codes of the user, in QR type formats.
